(19) United States
(12) Patent Application Publication
(10) Pub. No.: US 2024/0165762 A1
(43) Pub. Date: May 23, 2024

(54) CUTTING DEVICE

(71) Applicant: Nanjing Chervon Industry Co., Ltd., Nanjing (CN)

(72) Inventors: Changning Zhang, Nanjing (CN); Zhifeng Chen, Nanjing (CN); Fangyong Sun, Nanjing (CN)

(21) Appl. No.: 18/424,007

(22) Filed: Jan. 26, 2024

Related U.S. Application Data
(63) Continuation of application No. PCT/CN2023/083980, filed on Mar. 27, 2023.

(30) Foreign Application Priority Data
Mar. 30, 2022 (CN) 202210328193.8
Mar. 30, 2022 (CN) 202210329386.5
Mar. 30, 2022 (CN) 202210330858.9
Mar. 30, 2022 (CN) 202220721796.X
Mar. 30, 2022 (CN) 202220722725.1
Mar. 30, 2022 (CN) 202220732462.2

(51) Int. Cl. B23Q 7/06; B23Q 3/00; B23Q 3/10; B23Q 16/04; B26D 1/03; B26D 7/02

(52) U.S. Cl. CPC B23Q 7/06; B23Q 3/102; B23Q 16/04; B26D 1/03; B26D 7/025; B23Q 3/005; B23Q 2705/14

(57) ABSTRACT

A cutting device includes a box, a workbench disposed on the box, and a cutting assembly disposed on the box, where the workbench includes a platen for carrying a workpiece, and the platen is provided with a first cutting slot along a first direction; the platen is slidably connected to the box along the first direction, and when the platen slides towards the cutting assembly, the cutting assembly penetrates through the first cutting slot so that the cutting assembly cuts the workpiece on the platen, where a slide stroke of the platen is greater than a cutting stroke of the workpiece.

### RELATED APPLICATION INFORMATION

This application is a continuation of International Application Number PCT/CN2023/083980, filed on Mar. 27, 2023, through which this application also claims the benefit under 35 U.S.C. § 119(a) of Chinese Patent Application No. 202210328193.8, filed on Mar. 30, 2022, Chinese Patent Application No. 202210330858.9, filed on Mar. 30, 2022, Chinese Patent Application No. 202210329386.5, filed on Mar. 30, 2022, Chinese Patent Application No. 202220721796.X, filed on Mar. 30, 2022, Chinese Patent Application No. 202220732462.2, filed on Mar. 30, 2022, and Chinese Patent Application No. 202220722725.1, filed on Mar. 30, 2022, which applications are incorporated herein by reference in their entireties.

### TECHNICAL FIELD

The present application relates to the technical field of cutters, for example, a cutting device.

### BACKGROUND

In the related art, a platen and a cutting tool are mainly arranged by two schemes. One scheme is to dispose the cutting tool on a side of the platen. When the cutting tool is disposed on a side of the platen, a fragile workpiece such as ceramics needs to be supported by hand after being cut to be prevented from falling on the ground and being broken. Such a scheme increases labor input. The other scheme is to space two platens apart and dispose the cutting tool between the two platens, where the two platens are used for supporting the workpiece separately so that the workpiece does not need to be supported by hand. However, when the two platens are fixed separately, the two platens may differ in height due to a mounting error or the like; during movement, the two platens may differ in speed, affecting cutting accuracy and resulting in poor cutting quality. Additionally, in the structure in the related art, a movement distance of the platen is the same as a cutting dimension of the workpiece. However, the platen may have a shorter movement distance due to an error during movement, and it is difficult to ensure that the cutting dimension of the workpiece meets an expected requirement

### SUMMARY

In one aspect, an example provides a cutting device. The cutting device includes a box, a workbench disposed on the box, and a cutting assembly disposed on the box, where the workbench includes a platen for carrying a workpiece, and the platen is provided with a first cutting slot along a first direction; the platen is slidably connected to the box along the first direction, and when the platen slides towards the cutting assembly, the cutting assembly penetrates through the first cutting slot so that the cutting assembly cuts the workpiece on the platen, where a slide stroke of the platen is greater than a cutting stroke of the workpiece.

In an example, the cutting device further includes a drive assembly and a power supply assembly which are disposed on the box, where the power supply assembly is used for supplying power to the drive assembly and disposed outside the box.

In an example, a surface of the platen has a working plane, the platen has a first projection on the working plane, and the power supply assembly has a second projection on the working plane, where the second projection is within the first projection.

In an example, the cutting device further includes the drive assembly and a switch which are disposed on the box, where the switch is used for controlling the drive assembly and disposed outside the box.

In an example, the cutting device includes a slide assembly including a track and a sliding sleeve moving on the track, where the track is connected to the box, and the sliding sleeve is connected to the platen.

In an example, the sliding sleeve has a motion slot, where the sliding sleeve is capable of sliding out of an end of the track through the motion slot so that the slide stroke of the platen is greater than or equal to the length of the track.

In an example, the cutting device further includes a main fence detachably connected to the platen, where the workpiece abuts against a first side of the main fence.

In an example, multiple mounting positions are provided on the platen, when the main fence is separately mounted at the multiple mounting positions, the first side of the main fence and the first direction are at different angles, and the main fence is capable of being selectively mounted at one of the multiple mounting positions.

In an example, the first side of the main fence is recessed towards a second side of the main fence to form a second cutting slot, and when the first side of the main fence is perpendicular to the first cutting slot, the second cutting slot communicates with the first cutting slot.

In an example, a lock assembly for locking the workbench is provided on the box to make the workbench stationary relative to the box.

In another aspect, an example provides a cutting device. The cutting device includes a box, a workbench disposed on the box, and a cutting assembly disposed on the box, where the workbench includes a platen for carrying a workpiece, and the platen is provided with a first cutting slot along a first direction; the platen is slidably connected to the box along the first direction, and when the platen slides towards the cutting assembly, the cutting assembly penetrates through the first cutting slot so that the cutting assembly cuts the workpiece on the platen; and the cutting device further includes a power supply assembly, a surface of the platen has a working plane, the platen has a first projection on the working plane, and the power supply assembly has a second projection on the working plane, where the second projection is at least partially within the first projection.

### BRIEF DESCRIPTION OF THE DRAWINGS

FIG. 1 is a structural view of a cutting device according to an example of the present application;

FIG. 2 is a side view of the cutting device in FIG. 1;

FIG. 3 is a schematic view of a workbench in motion in the cutting device in FIG. 1;

FIG. 4 is a top view of the cutting device in FIG. 1;

FIG. 5 is a schematic view of the cutting device of FIG. 1 without a workbench;

FIG. 6 is a structural view of a slide assembly in FIG. 5;

FIG. 7 is a sectional view of the slide assembly in FIG. 6;

FIG. 8 is an exploded view of the slide assembly in FIG. 6;

FIG. 9 is a schematic view of the cutting device of FIG. 1 with part of a workbench;

FIG. 10 is a schematic view of the cutting device of FIG. 1 without a workbench from another perspective;

FIG. 11 is a structural view of an elastic assembly mounted on a platen in the cutting device in FIG. 1;

FIG. 12 is a structural view of the bottom side of a workbench in the cutting device in FIG. 1;

FIG. 13 is an enlarged view of part I in FIG. 12;

FIG. 14 is a structural view of the top side of a workbench in FIG. 1;

FIG. 15 is an enlarged view of part II in FIG. 14;

FIG. 16 is a sectional view of an angle adjuster and a main fence in FIG. 14;

FIG. 17 is a structural view of the bottom side of a main fence in FIG. 14;

FIG. 18 is an enlarged view of part III in FIG. 17;

FIG. 19 is a structural view of the top side of a main fence in FIG. 14;

FIG. 20 is a sectional view of FIG. 19 along A-A;

FIG. 21 is a sectional view of FIG. 19 along B-B;

FIG. 22 is an enlarged view of part IV in FIG. 14;

FIG. 23 is a structural view of a first adjustment assembly in FIG. 14;

FIG. 24 is an enlarged view of part V in FIG. 12;

FIG. 25 is a structural view of a second adjustment assembly in FIG. 14;

FIG. 26 is an enlarged view of part VI in FIG. 12;

FIG. 27 is a schematic view of a second adjustment assembly of FIG. 12 mounted on a platen;

FIG. 28 is a structural view of a secondary fence of a cutting device on a platen;

FIG. 29 is an enlarged view of part VII in FIG. 10;

FIG. 30 is an exploded view of a blade follower assembly of a cutting device;

FIG. 31 is an enlarged view of part VIII in FIG. 30;

FIG. 32 is a schematic view of a cutting device without a workbench from a third perspective;

FIG. 33 is a sectional view of FIG. 32 along C-C;

FIG. 34 is a sectional view of FIG. 32 along D-D;

FIG. 35 is an enlarged view of part IX in FIG. 34;

FIG. 36 is a partial view of a blade follower assembly of a cutting device;

FIG. 37 is an exploded view of a blade follower assembly of a cutting device;

FIG. 38 is another exploded view of the blade follower assembly in FIG. 37;

FIG. 39 is a schematic view of a cutting device without a workbench according to another example; and

FIG. 40 is an enlarged view of part X in FIG. 39.

### DETAILED DESCRIPTION

In the description of the present application, terms “joined”, “connected”, and “fixed” are to be understood in a broad sense unless otherwise expressly specified and limited. For example, the term “connected” may refer to “fixedly connected”, “detachably connected”, or “integrated”, may refer to “mechanically connected” or “electrically connected”, or may refer to “connected directly”, “connected indirectly through an intermediary”, or “connected inside two components” or an interaction relation between two components. For those of ordinary skill in the art, specific meanings of the preceding terms in the present application may be understood based on specific situations.

In the present application, unless otherwise expressly specified and limited, when a first feature is described as “on” or “under” a second feature, the first feature and the second feature may be in direct contact or may be in indirect contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

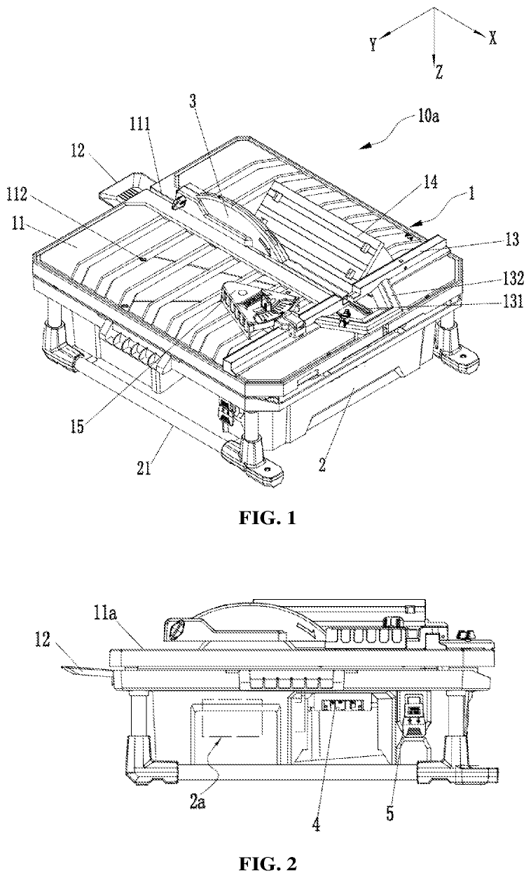

FIG. 1 provides a cutting device 10a. The cutting device 10a includes a box 2, a workbench 1 disposed on the box 2, and a cutting assembly 3 at least partially disposed in the box 2. The cutting device 10a may be used for cutting a workpiece such as a ceramic tile.

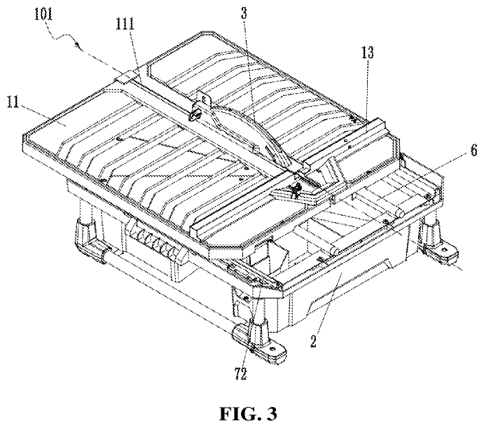

In an example, as shown in FIGS. 1 to 3, the workbench 1 includes a platen 11 for carrying the workpiece, and the platen 11 is provided with a first cutting slot 111 along a first direction 101. The platen 11 is slidably connected to the box 2 along the first direction 101. When the platen 11 slides towards the cutting assembly 3, the cutting assembly 3 penetrates through the first cutting slot 111 so that the cutting assembly 3 cuts the workpiece on the platen 11, where a slide stroke of the platen 11 is greater than a cutting stroke of the workpiece.

The first cutting slot 111 is formed on the platen 11 and extends in the same direction as a direction of movement of the platen 11, the cutting assembly 3 penetrates through the first cutting slot 111, and the platen 11 slides towards the cutting assembly 3 so that the workpiece on the platen 11 is automatically cut along the first direction 101. The slide stroke of the platen 11 is greater than the cutting stroke of the workpiece, that is, the slide stroke of the platen 11 is greater than a cutting length of the workpiece so that the cutting length of the workpiece is increased, ensuring that a cutting dimension of the workpiece meets an expected requirement. The platen 11 is an integral structure, and the workpiece is carried on the platen 11 so that a height difference can be avoided; and the entire platen 11 may move together so that a movement speed difference can be avoided, thereby improving cutting accuracy and cutting quality. Moreover, the cut workpiece is located on the platen 11 on two sides of the first cutting slot 111 separately and does not require manual support or an additional support structure, facilitating use.

In this example, as shown in FIG. 1, the first direction 101 is direction X, a second direction is direction Y, a third direction is direction Z, and the first direction, the second direction, and the third direction are perpendicular to each other. In this example, the first direction 101 is a front and rear direction of the cutting device 10a, the second direction is a left and right direction of the cutting device 10a, and the third direction is an up and down direction of the cutting device 10a.

In an example, the slide stroke of the platen 11 may be slightly greater than the cutting stroke of the workpiece. Optionally, the slide stroke of the platen 11 may be 3 inches, 4 inches, or 5 to 10 inches greater than the cutting stroke of the workpiece.

Optionally, as shown in FIG. 2, the cutting device 10a further includes a drive assembly 2a and a power supply assembly 4 which are disposed on the box 2, where the power supply assembly 4 is used for supplying power to the drive assembly 2a, and the drive assembly 2a is used for driving the platen 11 to reciprocate along the first direction 101. In an example, the power supply assembly 4 is disposed outside the box 2. In one aspect, when the power supply assembly 4 needs to be connected to a power supply, it is convenient to operate. In the other aspect, the box 2 has a relatively compact internal space, and the arrangement of the power supply assembly 4 outside facilitates a layout. In other examples, the platen 11 may be manually pushed to reciprocate. No limitation is made.

Optionally, in conjunction with FIGS. 1 to 4, a surface of the platen 11 has a working plane 11a, the platen 11 has a first projection on the working plane 11a, and the power supply assembly 4 has a second projection on the working plane 11a, where the second projection is within the first projection, so as to prevent the power supply assembly 4 from protruding from the platen 11 along the first direction or the second direction and improve structural compactness. During movement of the platen 11, the second projection of the power supply assembly 4 mounted on the box 2 is guaranteed to be always within the first projection, so as to limit a movement distance of the platen 11 and prevent the platen 11 from sliding off due to too large a slide distance. In an example, the power supply assembly 4 is disposed below the platen 11, and the power supply assembly 4 is spaced apart from a lower surface of the platen 11 to prevent structural interference between the power supply assembly 4 and the platen 11 in motion.

Optionally, as shown in FIG. 2, the cutting device 10a further includes the drive assembly 2a and a switch 5 disposed on the box 2, where the switch 5 is used for controlling the drive assembly 2a. The switch 5 is disposed to facilitate the start and stop of the drive assembly 2a and disposed outside the box 2 to be convenient to operate. In an example, in conjunction with FIGS. 2 to 4, the switch 5 has a third projection on the working plane 11a, where the third projection is within the first projection, so as to prevent the switch 5 from protruding from the platen 11 along the first direction or the second direction and improve the structural compactness. Moreover, the switch 5 is disposed on the box 2 and spaced apart from the platen 11, so as to avoid interference.

In this example, a transmission assembly (not shown) is further included. The transmission assembly adopts a gear and a rack, for example, the gear is rotatably connected to the box 2, the rack is fixed to the platen 11 of the workbench 1, and the rack and the gear mesh for transmission. The drive assembly 2a includes an electric motor (not shown) for driving the gear to rotate to drive the rack to move, thereby moving the platen 11. The gear and the rack do not limit the strode of the platen 11.

As shown in FIG. 1, the box 2 is provided with cross bars 21 that can be supported on the ground. Additionally, the cross bars 21 may be used as a handle. The cross bars 21 may be held so that the cutting device 10a is moved. In an example, the cross bars 21 may be provided in the front and rear of and/or on the left and right of the box 2.

As shown in FIG. 5, an accommodation cavity is formed in the box 2, and a liquid is provided in the accommodation cavity to perform dusting on the cut workpiece or the environment.

As shown in FIGS. 5 to 7, the cutting device 10a includes a slide assembly 6, the slide assembly 6 includes a track 61 and a sliding sleeve 62 moving on the track 61, and the track 61 is connected to the box 2. The sliding sleeve 62 is connected to the workbench 1. The sliding sleeve 62 moves along the track 61, increasing movement accuracy of the workbench 1, preventing a deflection, and increasing the cutting accuracy of the workpiece on the workbench 1. In this example, the track 61 extends along the first direction 101. In an example, the sliding sleeve 62 has a motion slot 62A through which the sliding sleeve 62 is capable of partially sliding out of an end of the track 61 so that a slide stroke of the sliding sleeve 62 on the track 61 is increased, and thus the slide stroke of the workbench 1 is greater than or equal to the length of the track 61, that is, the slide stroke of the workbench 1 is greater than the cutting length of the workpiece, thereby increasing the cutting length of the workpiece and ensuring that the cutting dimension of the workpiece meets the expected requirement.

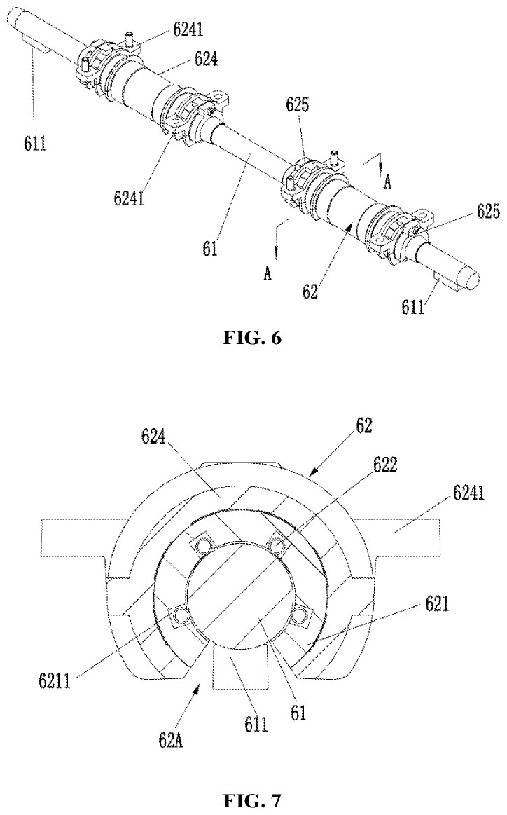

Referring to FIGS. 6 and 7, the track 61 has a connecting portion 611 through which the track 61 is disposed on the box 2. The sliding sleeve 62 is sleeved on the track 61 and slidably connected to the track 61, and the motion slot 62A is capable of passing the connecting portion 611. During movement, the connecting portion 611 does not limit the movement of the motion slot 62A so that at least part of the sliding sleeve 62 can pass the connecting portion 611 to slide out of the connecting portion 611 of the track 61, thereby extending the slide stroke of the sliding sleeve 62 and ensuring the slide stroke of the platen 11 of the workbench 1.

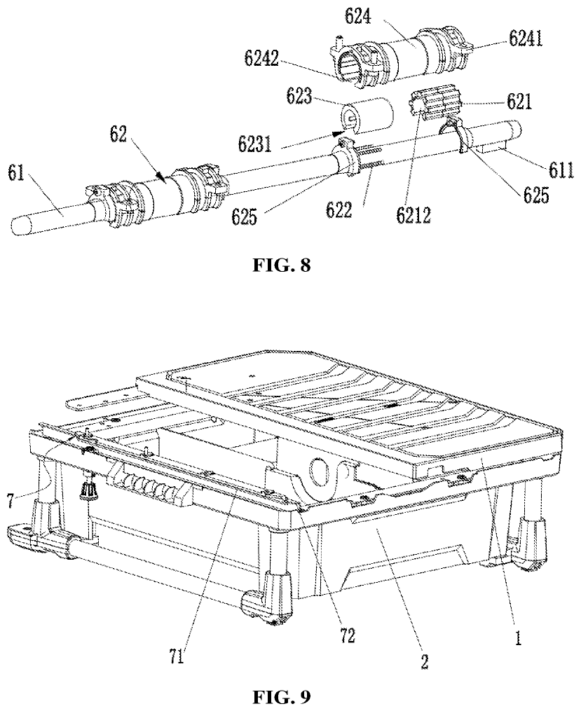

In this example, referring to FIGS. 7 and 8, the sliding sleeve 62 includes a bearing 621 with a first slot 6212 forming part of the motion slot 62A, where balls 622 in contact with the track 61 are provided in the first slot 6212. The balls 622 are disposed so that the sliding friction between the bearing 621 and the track 61 becomes rolling friction, thereby reducing the friction between the sliding sleeve 62 and the track 61 and prolonging a service life of the slide assembly 6.

An inner wall of the bearing 621 adapts to the appearance of the track 61 so that the bearing 621 and the track 61 are circumferentially limited. The inner wall of the bearing 621 is provided with multiple mounting slots 6211, and multiple lines of balls 622 are provided, where one line of balls 622 is mounted in each mounting slot 6211, thereby increasing the number of balls 622 and further reducing the friction.

The sliding sleeve 62 further includes a housing 624 with a second slot 6242, the housing 624 is sleeved on an outer circumference of the bearing 621, the second slot 6242 forms part of the motion slot 62A, and the housing 624 is connected to the workbench 1. In one aspect, the housing 624 mates with the bearing 621, the housing 624 is connected to the workbench 1, and the bearing 621 is slidably connected to the track 61 so that the workbench 1 is slidably connected to the track 61. Additionally, to facilitate the machining of the bearing 621, the length of the bearing 621 may be reduced, and multiple bearings 621 may be provided so that the multiple bearings 621 are separately disposed in the same housing 624 to form an integral structure, thereby facilitating installation.

Since the bearing 621 has a relatively complex structure and is machined with a high cost, the sliding sleeve 62 further includes a spacer frame 623, the spacer frame 623 and the bearing 621 are separately inserted into the housing 624 along a centerline direction of the housing 624, and the spacer frame 623 is inserted through the track 61 and has a third slot 6231 forming part of the motion slot 62A. The spacer frame 623 is disposed so that the number of bearings 621 used is reduced, thereby reducing a cost. In an example, the spacer frame 623 may be slidably connected to the track 61 to improve sliding stability, or the spacer frame 623 may not be connected to the track 61 to reduce the friction.

Multiple bearings 621 and multiple spacer frames 623 may be spaced apart from each other according to use requirements. In this example, two bearings 621 are disposed, and the spacer frame 623 is disposed between the two bearings 621.

Ear plates 6241 are provided on an outer circumference of the housing 624, each ear plate 6241 is provided with a mounting hole, and a fastener penetrates through the mounting hole and a connecting hole of the workbench 1 so that the ear plate 6241 is connected to the workbench 1, which are detachably connected through the fastener, thereby facilitating detachment and installation.

Optionally, referring to FIGS. 6 and 8, the sliding sleeve 62 further includes a barrier sleeve 625 that can be sleeved on the track 61, the barrier sleeve 625 is connected to an end of the housing 624, the barrier sleeve 625 abuts against the bearing 621, and the barrier sleeve 625 is used for axially limiting the bearing 621 to prevent the bearing 621 and the housing 624 from sliding off.

As shown in FIG. 7, the connecting portion 611 is a support block protruding from an outer circumference of the track 61, the support block is fixed to the box 2, and a slot dimension of the motion slot 62A is greater than the width of the support block.

As shown in FIG. 5, multiple slide assemblies 6 are disposed, multiple tracks 61 are arranged in parallel, the support block is fixed to a sidewall of the box 2, and at least one sliding sleeve 62 is disposed on each track 61. In this example, two tracks 61 are disposed on the box 2, two sliding sleeves 62 are disposed on each track 61, the two sliding sleeves 62 are symmetrically arranged and spaced apart, and the two sliding sleeves 62 can protrude from two ends of the track 61, respectively. In an example, the two tracks 61 are disposed on two sides of the cutting assembly 3, and sliding sleeves 62 on the two tracks 61 are connected to the platen 11 of the workbench 1 separately, and the platen 11 is evenly stressed to prevent the sliding sleeves 62 and the cutting assembly 3 from interfering with each other.

The cutting device 10a further includes an adjustment block provided on a side surface of the track 61 and in the shape of a cam, and the adjustment block rotates to enable the track 61 to adjust its position along the second direction to adjust the distance from the cutting assembly 3. Since the platen 11 is connected to the sliding sleeves 62, the parallelism between the platen 11 and the cutting assembly 3 can be adjusted, thereby improving the cutting accuracy.

A lock assembly 9 for locking the workbench 1 is provided on the box 2 to make the workbench 1 stationary relative to the box 2. The lock assembly 9 is particularly applicable to the case where the cutting device 10a does not require the movement of the platen 11 during transportation, storage, or the cutting of a relatively long workpiece. As shown in FIG. 5, a rib with a slope and a locking pin with a spring are provided on the outside of the box 2, the rib is provided with a first mounting hole, the platen 11 is provided with a second mounting hole, and the locking pin can penetrate through the first mounting hole and the second mounting hole to fix the platen 11 to the outside of the box 2 and lock the platen 11 so that the platen 11 does not slide. The locking pin is pressed against the rib through the spring, and the rib with the slope can provide a fuzzy alignment function within a certain range so that the first mounting hole can be automatically aligned within a certain range, thereby facilitating operation.

In this example, the cutting device 10a includes a guide rail assembly 7. As shown in FIGS. 5 and 9, the guide rail assembly 7 is disposed between the workbench 1 and the box 2, and the guide rail assembly 7 is disposed along the first direction 101 to increase, together with the slide assembly 6, the slide accuracy of the workbench 1 along the first direction 101 on the box 2. In an example, as shown in FIG. 5, the guide rail assembly 7 includes a first guide rail 71 disposed on the workbench 1 and a second guide rail 72 disposed on the box 2, where the first guide rail 71 and the second guide rail 72 mate with each other and move relatively. One of the first guide rail 71 and the second guide rail 72 is provided with a guide boss, and the other of the first guide rail 71 and the second guide rail 72 is provided with a guide groove mating with the guide boss.

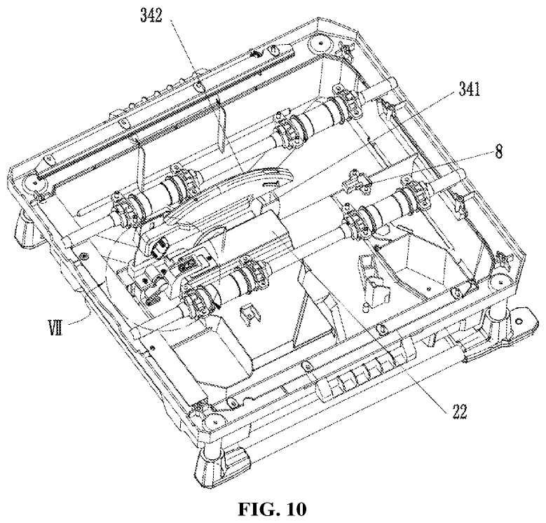

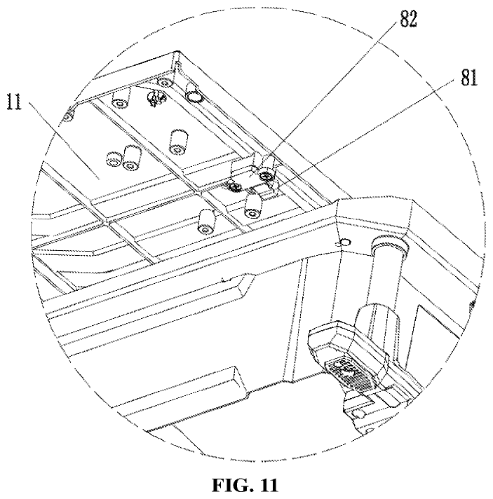

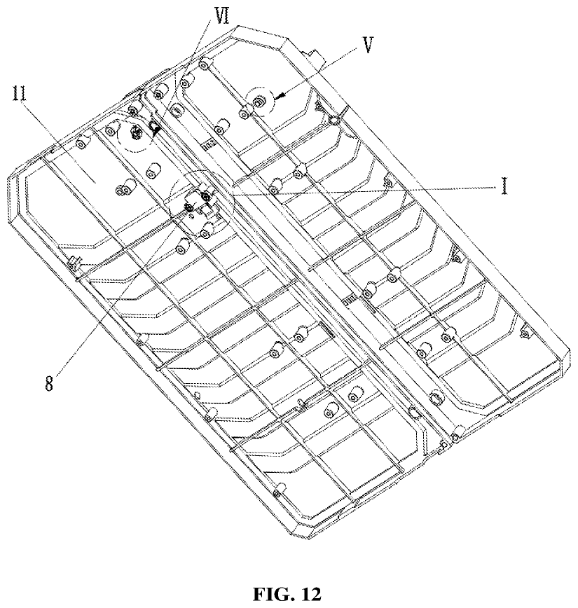

Optionally, as shown in FIGS. 10 to 13, the cutting device 10a further includes a resistance mechanism. In an example, the resistance mechanism includes an elastic assembly 8 and a stop 22, one of the elastic assembly 8 and the stop 22 is disposed on the box 2, and the other of the elastic assembly 8 and the stop 22 is disposed on the workbench 1. When the workbench 1 moves to a preset position, the elastic assembly 8 abuts against the stop 22. During the movement of the workbench 1 from the preset position to a limit position, the elastic assembly 8 is pressed against the stop 22 to provide resistance for the workbench 1.

The elastic assembly 8 and the stop 22 are disposed so that when the workbench 1 slides to the preset position, the elastic assembly 8 and the stop 22 come into contact. As the workbench 1 continues to slide, the elastic assembly 8 is pressed against the stop 22, and a pressing force gradually increases. During the movement of the workbench 1 from the preset position along a negative direction of X, the elastic assembly 8 and the stop 22 provide gradually increased resistance so that a speed of the workpiece on the workbench 1 relative to the cutting assembly 3 on the box 2 is reduced, and an impact force between the cutting assembly 3 and the workpiece is reduced, providing more stable operation and reducing an angle of collapse of a cutting member 31 at the end of the cutting due to improper operation.

The elastic assembly 8 includes an elastic member 81, and a fixed end of the elastic member 81 is fixed to the workbench 1 or the box 2. The elastic member 81 may be a spring or other structures and is convenient to use. The elastic assembly 8 further includes a fixing frame 82, the elastic member 81 is fixed to the fixing frame 82, the fixing frame 82 is connected to the workbench 1 or the box 2, and the elastic member 81 faces the stop 22.

One of the elastic assembly 8 and the stop 22 is disposed on a side of the platen 11 facing the box 2, and the resistance mechanism is disposed between sliding surfaces of the platen 11 and the box 2, so as to avoid an exposed structure and achieve a more compact structure.

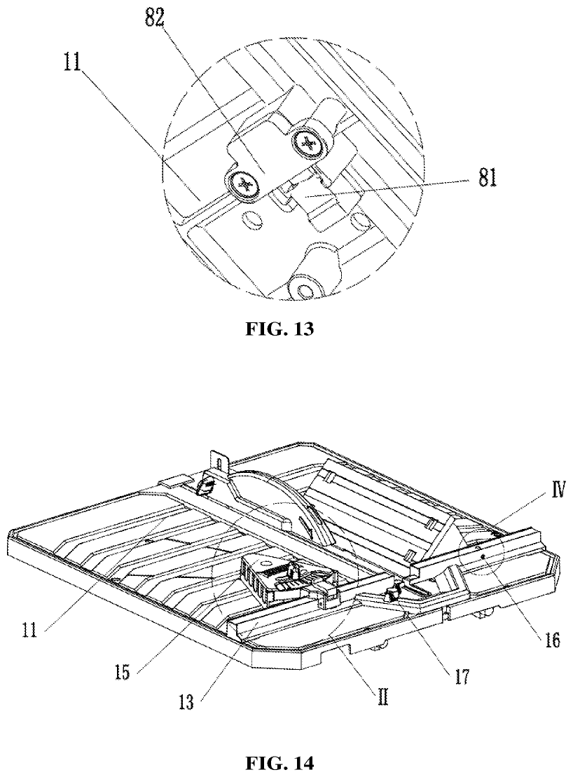

In this example, as shown in FIG. 13, the elastic member 81 is fixed to the fixing frame 82, the fixing frame 82 is connected to the side of the platen 11 facing the box 2 through fasteners, and the box 2 is provided with the stop 22.

The distance between the preset position and the limit position is 10 mm to 15 mm. Too large a distance affects an overall cutting speed, and too small a distance cannot avoid the angle of collapse.

The magnitude of the resistance is 10 N to 50 N. Too large a resistance increases cutting difficulty and affects an overall cutting effect. Too small a resistance cannot avoid the angle of collapse. In some examples, the resistance is 30 N.

As shown in FIGS. 1, 2, and 4, a protective block 12 is detachably connected to an end of the platen 11, and the protective block 12 can block the first cutting slot 111. When the workpiece is cut, a user is located on a side of the box 2 facing away from the protective block 12. When the platen 11 does not move or moves away from the user, the protective block 12 moves with the platen 11 so that the structure of the platen 11 can be strengthened. When the platen 11 moves towards the user, the protective block 12 may be detached to avoid the cutting assembly 3, or the protective block 12 can rotate about an axis parallel to the first direction 101 to avoid the cutting assembly 3.

Optionally, as shown in FIGS. 1, 3, and 4, the cutting device 10a further includes a main fence 13, the main fence 13 is detachably connected to the platen 11, and the workpiece abuts against a first side of the main fence 13. When the platen 11 slides towards the cutting assembly 3, the cutting assembly 3 exerts a force on the workpiece on the platen 11 along an opposite direction of a movement direction of the platen 11, and the main fence 13 abuts against the workpiece so that the workpiece can be prevented from moving backwards when subjected to the force, which affects cutting reliability and cutting accuracy.

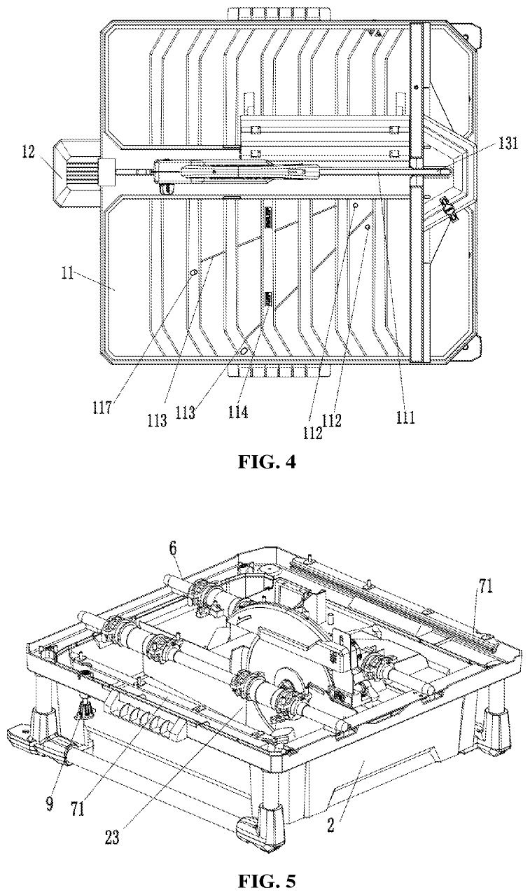

As shown in FIGS. 1 and 4, the first side of the main fence 13 is recessed towards a second side of the main fence 13 to form a second cutting slot 131, and when the first side of the main fence 13 is perpendicular to the first cutting slot 111, that is, the first side is at an angle of 90° relative to the first cutting slot 111, the second cutting slot 131 communicates with the first cutting slot 111. When the slide stroke of the platen 11 exceeds the cutting stroke of the workpiece, the cutting assembly 3 penetrates through the second cutting slot 131 so that the main fence 13 is prevented from affecting the slide stroke of the platen 11 and also prevented from being cut and damaged when the slide stroke of the platen 11 exceeds the cutting stroke of the workpiece. In an example, the length of the second cutting slot 131 along the first direction 101 is not less than a dimension of the slide stroke of the platen 11 beyond the cutting stroke of the workpiece.

As shown in FIG. 1, a protrusion 132 protrudes from the second side of the main fence 13, and the second cutting slot 131 extends to the protrusion 132. The main fence 13 is relatively narrow in structure, and the protrusion 132 is disposed so that the main fence 13 can be prevented from being divided into two parts by the second cutting slot 131, and the main fence 13 is still integral and convenient and reliable.

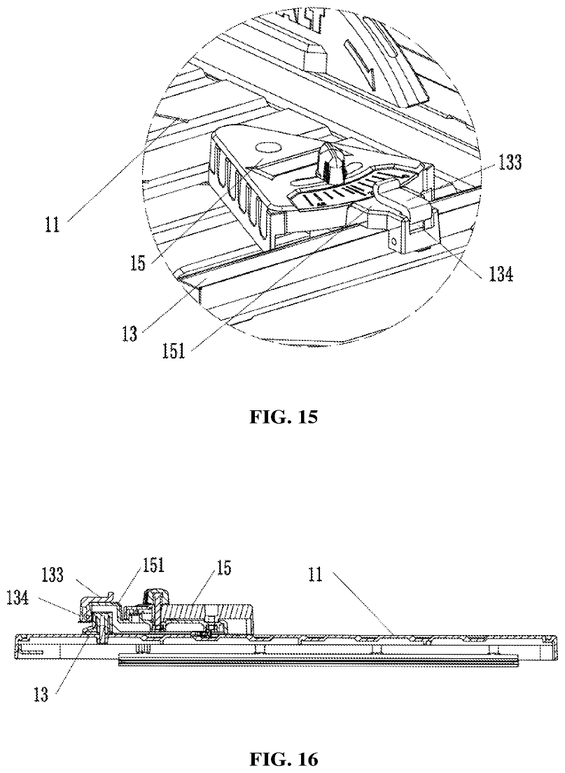

As shown in FIGS. 14 and 15, an angle adjuster 15 is further provided on the platen 11. A position of the main fence 13 on the platen 11 is adjusted through the angle adjuster 15, thereby improving mounting accuracy of the main fence 13 and mounting accuracy of the workpiece and improving the cutting accuracy of the workpiece.

As shown in FIGS. 15 and 16, the angle adjuster 15 has a housing 151, the main fence 13 is rotatably connected to a first connecting plate of an L-shaped operating member 133, a second connecting plate of the L-shaped operating member 133 abuts against the housing 151, an elastic piece 134 is further fixed on the main fence 13, and the elastic piece 134 abuts against the first connecting plate. When a mounting position of the main fence 13 needs to be adjusted, the second connecting plate is lifted up so that the main fence 13 is separated from the angle adjuster 15. When the adjustment is completed, the second connecting plate is lowered down so that the main fence 13 abuts against the housing 151, and the angle adjuster 15 and the main fence 13 are fixed to each other, thereby preventing the main fence 13 from moving, which affects the mounting accuracy.

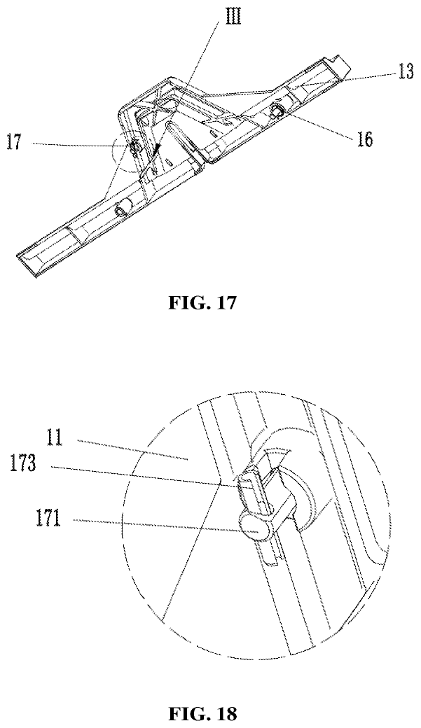

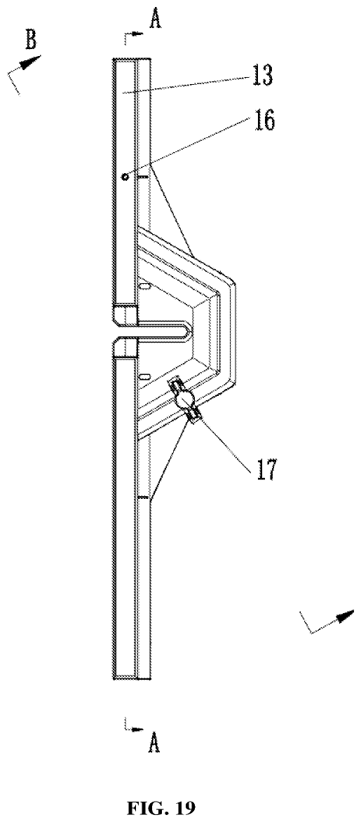

As shown in FIGS. 14 and 16 to 19, the workbench 1 further includes a first adjustment assembly 16 and a second adjustment assembly 17. In an example, the first adjustment assembly 16 includes a fixed end detachably connected to the platen 11, the main fence 13 can rotate about the fixed end of the first adjustment assembly 16 to adjust an angle, and the first adjustment assembly 16 and the main fence 13 can be fixed to each other. The second adjustment assembly 17 is detachably connected to the platen 11, and the main fence 13 can be fixed to the platen 11 through the second adjustment assembly 17.

The main fence 13 is fixed to the platen 11 through the first adjustment assembly 16 and the second adjustment assembly 17. During use, the fixed end of the first adjustment assembly 16 is connected to the platen 11, and the second adjustment assembly 17 is detached from the platen 11. Then, the main fence 13 rotates about the fixed end of the first adjustment assembly 16 to be adjusted to a desired angle. Finally, the first adjustment assembly 16 and the main fence 13 are fixed to each other, and the main fence 13 is fixed to the platen 11 through the second adjustment assembly 17. The main fence 13 rotates about the first adjustment assembly 16 so that the position of the main fence 13 relative to the platen 11 is finely adjusted, and then the main fence 13 is locked to the platen 11 through the first adjustment assembly 16 and the second adjustment assembly 17, thereby improving the mounting accuracy of the main fence 13, the cutting accuracy, and the cutting quality.

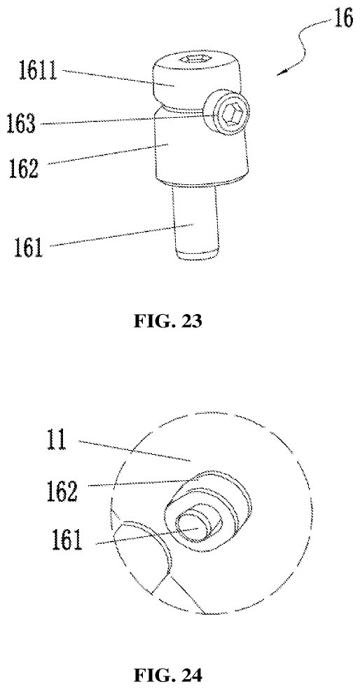

As shown in FIGS. 4, 20, and 22 to 24, the first adjustment assembly 16 includes a wheel 162 and an adjustment pin 161, where the wheel 162 is fixed to the main fence 13, an end of the adjustment pin 161 is connected to the platen 11, the wheel 162 is rotatably connected to the other end of the adjustment pin 161, and the adjustment pin 161 is eccentrically disposed in the wheel 162. In an example, the platen 11 is provided with a mounting hole 112, and the adjustment pin 161 penetrates through the mounting hole 112. During use, the adjustment pin 161 is fixed to the platen 11, the main fence 13 is connected to the wheel 162, and the main fence 13 is operated to drive the wheel 162 to rotate on the adjustment pin 161 so that the main fence 13 rotates relative to the platen 11 by an angle. The angle is adjusted to adjust an angle between the main fence 13 and the cutting member 31. The perpendicularity of the angle between the main fence 13 and the cutting member 31 is a key parameter.

In other examples, the first adjustment assembly 16 includes the wheel 162 and the adjustment pin 161, and the main fence 13 is fixed to the wheel 162. An end of the adjustment pin 161 is connected to the platen 11, the wheel 162 is rotatably connected to the other end of the adjustment pin 161, and the center of the adjustment pin 161 is not on the central axis of the wheel 162. For example, the wheel 162 has an eccentric shape.

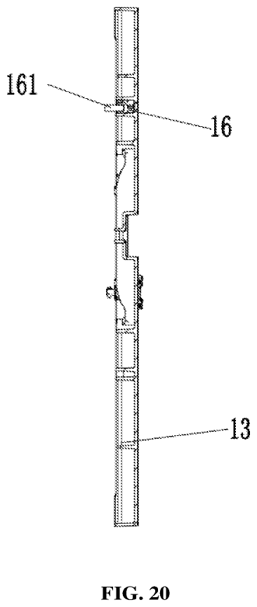

As shown in FIGS. 20 and 22 to 24, the first adjustment assembly 16 further includes a latch 163, the main fence 13 is provided with an insertion hole 135, and the latch 163 can penetrate through the insertion hole 135 and be connected to the adjustment pin 161. The latch 163 is inserted through the insertion hole 135 of the main fence 13 to fix the main fence 13, the first adjustment assembly 16, and the platen 11 together. The first adjustment assembly 16 is simple in structure and convenient to operate.

An edge protrusion 1611 is provided at the top of the adjustment pin 161, and the edge protrusion 1611 is fixed to the main fence 13 to achieve axial limitation.

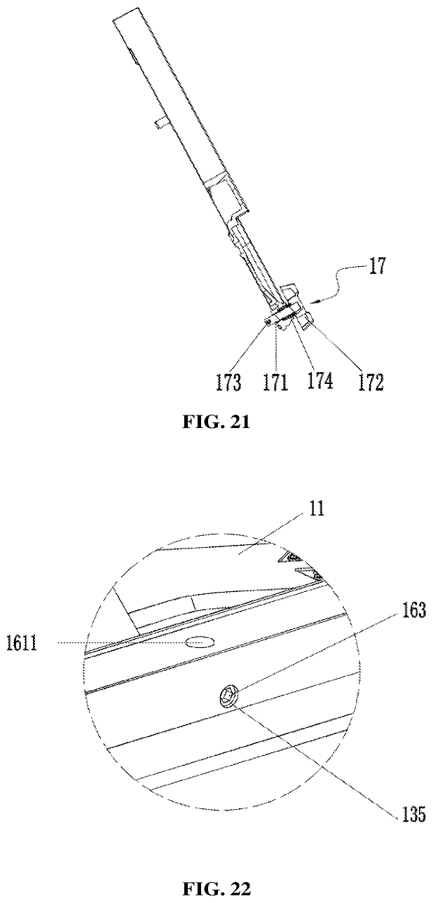

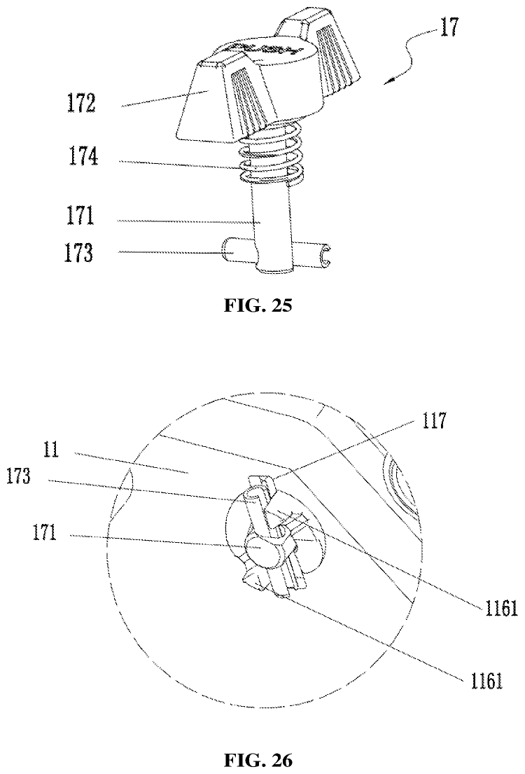

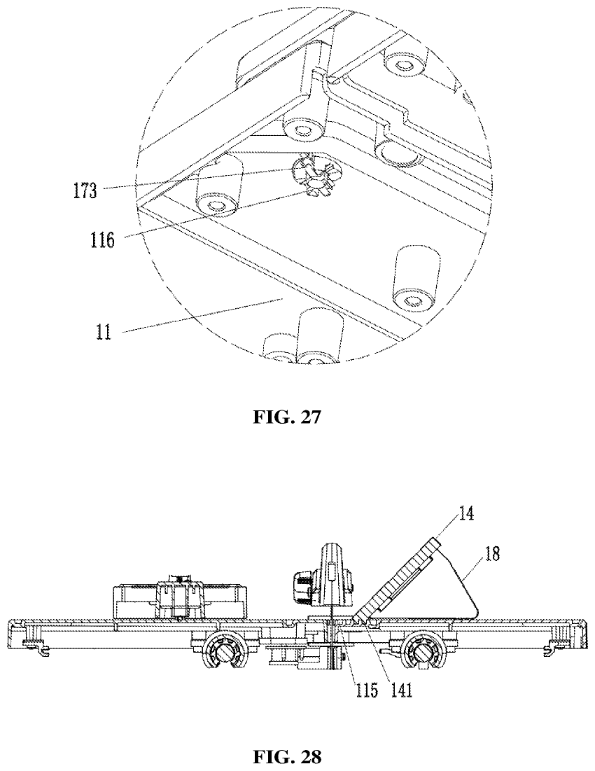

As shown in FIGS. 18, 21, and 25 to 27, the second adjustment assembly 17 includes a spindle 171 and a limiting shaft 173. When operated to rotate relative to the main fence 13, an end of the spindle 171 penetrates through the main fence 13 and the platen 11 and extends out of the platen 11. The limiting shaft 173 is connected to an end of the spindle 171 extending out of the platen 11, and the platen 11 is provided with a limiting portion 116 for limiting the rotation of the limiting shaft 173 and the spindle 171. When the limiting shaft 173 is limited by the limiting portion 116, circumferential limitation and fixation are achieved.

The second adjustment assembly 17 includes an operating member 172 and a spring 174, the operating member 172 is connected to the other end of the spindle 171, and the operating member 172 can abut against a side of the main fence 13 facing away from the platen 11. The spring 174 is sleeved on the spindle 171, an end of the spring 174 abuts against the operating member 172, and the other end of the spring 174 can abut against the platen 11. The spring 174 is compressed so that the limiting shaft 173 can be disengaged from the limiting portion 116. The spring 174 automatically springs up so that the limiting shaft 173 automatically abuts against the limiting portion 116 along an axial direction for limitation. When the spindle 171 continues to move downwards under the action of the operating member 172, the limiting shaft 173 goes beyond the limiting portion 116 and reaches a via 117 and can be retracted to the main fence 13.

As shown in FIG. 26, the platen 11 has the via 117, and the limiting portion 116 includes two protrusions 1161 protruding out of the platen 11, where a communication slot communicating with the via 117 is formed on sides of the two protrusions 1161 facing each other, and a limiting groove is formed on sides of the two protrusions 1161 facing away from each other and used for limiting the limiting shaft 173.

As shown in FIG. 4, multiple sets of second mounting positions are provided on the platen 11. The main fence 13 is disposed on the platen 11 and used for limiting the workpiece. The first adjustment assembly 16 and the second adjustment assembly 17 can be selectively locked at one of the multiple sets of second mounting positions. When the main fence 13 is fixed to the platen 11 through the first adjustment assembly 16 and the second adjustment assembly 17, a limiting surface of the main fence 13 and the cutting member 31 of the cutting assembly 3 form a corresponding angle.

When the main fence 13 is separately mounted at multiple second mounting positions, the first side of the main fence 13 and the first direction are at different angles so that the workpiece can be cut at multiple cutting angles to reach multiple shaping requirements, thereby adapting to multiple cutting requirements. In this example, referring to FIG. 4, the platen 11 is provided with two guide lines 113, one guide line 113 and an extension direction of the first cutting slot 111 are at an angle of 22.5°, the other guide line 113 and the extension direction of the first cutting slot 111 are at an angle of 45°, and the first side of the main fence 13 can be flush with the guide line 113 so that a side surface of the workpiece can be flush with the guide line 113 to achieve accurate cutting at the corresponding angle. In other examples, the number of guide lines 113 and the angle between the guide line 113 and the extension direction of the first cutting slot 111 can be set according to actual situations. Optionally, the guide line 113 is parallel to the extension direction of the first cutting slot 111, and an operator may hold the main fence 13 to perform manual cutting.

Referring to FIG. 4, the platen 11 is provided with a mounting structure, and the main fence 13 is detachably connected to the mounting structure on the platen 11. When cutting needs to be performed at different angles, the main fence 13 is convenient to detach and install. In an example, referring to FIG. 4, the platen 11 is provided with indicators 114, which may indicate numbers such as 22.5 or 45° to facilitation identification. In an example, for the specific structures of the first adjustment assembly 16 and the second adjustment assembly 17, reference is made to example one, and the details are not repeated here.

In other examples, the first adjustment assembly includes the fixed end detachably connected to the platen, the main fence can rotate about the fixed end of the first adjustment assembly to adjust the angle, and the first adjustment assembly and the main fence can be fixed to each other. The main fence is mounted on the platen by using only the first adjustment assembly, which is simple in structure.

In other examples, the second adjustment assembly is detachably connected to the platen, and the main fence can be fixed to the platen through the second adjustment assembly. The main fence is mounted on the platen by using only the second adjustment assembly, which is simple in structure.

As shown in FIG. 28, the platen 11 is provided with the first cutting slot 111 along the first direction 101, the cutting assembly 3 can penetrate through the first cutting slot 111, multiple first mounting positions are provided on the platen 11 along the second direction, the workbench 1 further includes a secondary fence 14 detachably connected to the platen 11, a working surface of the secondary fence 14 and a working surface of the platen 11 are at an angle, and the secondary fence 14 can be selectively mounted at one of the multiple first mounting positions so that the chamfered workpiece can be moved in a direction perpendicular to the cutting assembly 3 and quickly positioned.

The secondary fence 14 is supported on the platen 11 by a support 18. A chamfer incremented at a scale of 2.5 mm can be provided, so as to provide the user with a better accuracy-controllable decorative chamfer cutting function. The platen 11 is provided with multiple insertion grooves 115 along the second direction, and an insertion boss 141 is provided at the bottom of the secondary fence 14. The insertion boss 141 can optionally be inserted into and mate with one of the multiple insertion grooves 115 for position adjustment. In some examples, the insertion grooves 115 are through holes, so as to prevent the insertion grooves 115 from dust and facilitate cleaning.

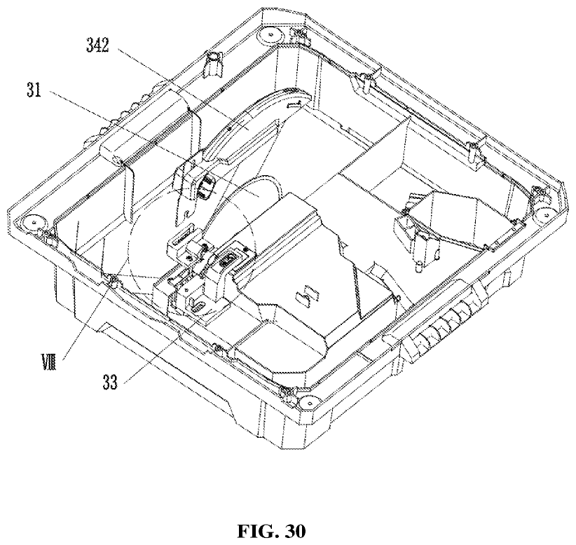

As shown in FIGS. 10 and 29 to 31, the cutting assembly 3 includes the cutting member 31 and a blade follower assembly 33, where the cutting member 31 rotates about an output shaft and is disposed on the output shaft in a replaceable manner. At least part of the blade follower assembly 33 is disposed on the rear side of the cutting member 31, and the blade follower assembly 33 is movable relative to the box 2 along the first direction 101 between at least a first position and a second position. When the blade follower assembly 33 moves from the first position to the second position, the distance between the blade follower assembly 33 and the output shaft increases.

The blade follower assembly 33 can move along the first direction 101 between the first position and the second position, and the distance between the blade follower assembly 33 and the output shaft is adjusted so that the distance between the blade follower assembly 33 and the cutting member 31 is adjusted. In this manner, a mounting position of the blade follower assembly 33 can be adjusted according to the cutting member 31, and the cutting member 31 can be prevented from cutting the blade follower assembly 33, thereby improving reliability. Specifically, the first position and the second position may be set according to dimensions of the cutting member 31 and the blade follower assembly 33. The position of the blade follower assembly 33 corresponds to the cutting member 31 so that the blade follower assembly 33 and the corresponding cutting member 31 are maintained at a preset distance, thereby preventing the cutting member 31 from cutting the blade follower assembly 33.

The cutting member 31 includes at least a first cutting member and a second cutting member with different dimensions, where the first cutting member is mounted to the output shaft when the blade follower assembly 33 is at the first position, and the second cutting member is mounted to the output shaft when the blade follower assembly 33 is at the second position. In this example, the cutting member 31 is a saw blade, including a saw blade of 7 inches and a saw blade of 8 inches separately. In other examples, multiple cutting members 31 may be provided, where dimensions of the multiple cutting members 31 are between a dimension of the first cutting member and a dimension of the second cutting member, and correspondingly, multiple mounting positions are provided between the first position and the second position, thereby further improving applicability. The blade follower assembly 33 includes a liming device. When the blade follower assembly 33 moves to the second position, the liming device restrains the blade follower assembly 33 from moving towards the first position. The liming device is disposed so that mounting reliability and mounting accuracy of the blade follower assembly 33 are improved.

The multiple cutting members 31 are disposed, which can meet the cutting requirements of different materials. The cutting members 31 with different dimensions are mounted to the output shaft so that the applicability to the cutting of different materials can be improved. When the cutting member 31 is replaced with one having a small dimension, the blade follower assembly 33 moves towards the output shaft. When the cutting member 31 is replaced with one having a large dimension, the blade follower assembly 33 moves away from the output shaft. The position of the blade follower assembly 33 corresponds to the cutting member 31 of a corresponding size so that the blade follower assembly 33 and the corresponding cutting member 31 are maintained at the preset distance, thereby preventing the cutting member 31 from cutting the blade follower assembly 33.

The blade follower assembly 33 is disposed on a mounting seat of the box 2, the limiting device includes multiple limiting blocks 32, the mounting seat is provided with multiple accommodation slots along the first direction 101, each limiting block 32 can be stretched out of or retracted into a respective accommodation slot, and the blade follower assembly 33 can abut against a side surface of the stretched limiting block 32. The corresponding limiting block 32 limits the blade follower assembly 33 to a corresponding position of the mounting seat, and the distance between the blade follower assembly 33 and the output shaft can be limited according to a dimension of the limiting block 32. In this example, one limiting block 32 is provided. When the limiting block 32 is stretched out of the accommodation slot, the blade follower assembly 33 is at the second position, and the blade follower assembly 33 abuts against the side surface of the limiting block 32. When the limiting block 32 is retracted into the accommodation slot, the blade follower assembly 33 is at the first position.

In an example, the limiting block 32 is connected in the accommodation slot through a spring. When the limiting block 32 at the corresponding position is not required for limiting, the limiting block 32 is pressed into the accommodation slot through the mounting seat. When the limiting block 32 is required for limiting, the mounting seat moves away from the output shaft to be off the top of the corresponding limiting block 32 so that the limiting block 32 is ejected for new limiting, which is convenient and reliable. The limiting block 32 also functions as a foolproof. If the user forgets to adjust the limiting block 32, a cutting risk may occur. When the mounting seat is moved, the limiting block 32 can be automatically ejected, so as to avoid an incorrect mounting position of the blade follower assembly 33.

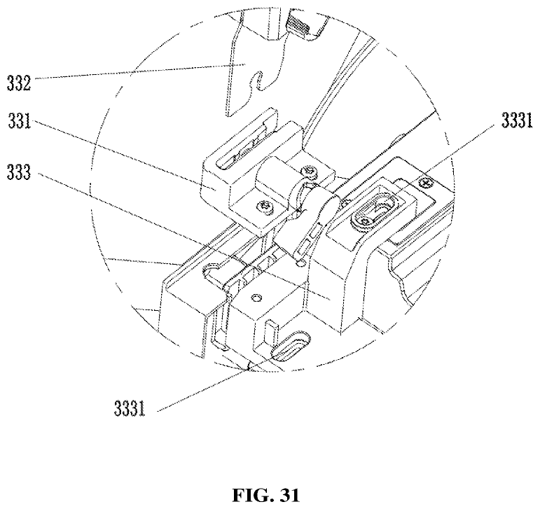

Optionally, as shown in FIG. 31, the blade follower assembly 33 includes an adapter seat 333 and a blade follower plate 332 disposed on the adapter seat 333, where the adapter seat 333 is adjustably mounted to the mounting seat of the box 2 along the first direction 101, the blade follower plate 332 is disposed on a side of the cutting member 31 along the first direction 101, and the blade follower plate 332 is maintained at a preset distance from the corresponding cutting member 31, so as to prevent the cutting member 31 from cutting and damaging the blade follower plate 332.

Optionally, the adapter seat 333 is provided with a first adjustment structure, and the adapter seat 333 is adjustably mounted to the mounting seat through the first adjustment structure, thereby facilitating adjustment of a mounting position of the adapter seat 333 on the mounting seat.

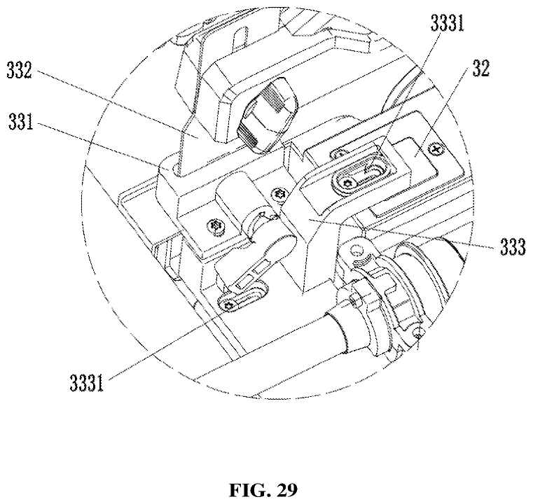

In an example, as shown in FIGS. 29 and 31, the first adjustment structure includes two first elongated holes 3331 formed on the adapter seat 333, where a length direction of each first elongated hole 3331 is the first direction 101. The mounting seat is provided with mounting seat holes, and fasteners penetrate through the first elongated holes 3331 and the mounting seat holes so that the adapter seat 333 is fixed to the mounting seat. The adapter seat 333 moves along the first direction 101 through the first elongated holes 3331 for adjustment, and the adapter seat 333 and the mounting seat are detachably connected through the fasteners, facilitating the adjustment.

The blade follower assembly 33 further includes a blade follower seat 331, the blade follower plate 332 and the adapter seat 333 are connected through the blade follower seat 331, and the blade follower seat 331, the blade follower plate 332, and the adapter seat 333 are provided separately, facilitating machining and use.

An interstice between contact surfaces of the blade follower seat 331 and the adapter seat 333 is not greater than 1 mm, so as to improve mounting accuracy between the blade follower seat 331 and the adapter seat 333. Optionally, one of the adapter seat 333 and the blade follower seat 331 is formed with a boss, and the other of the adapter seat 333 and the blade follower seat 331 is correspondingly formed with an insertion hole into which the boss can be inserted, facilitating detachment and installation.

The cutting assembly 3 further includes a protective system to prevent a water flow from splashing.

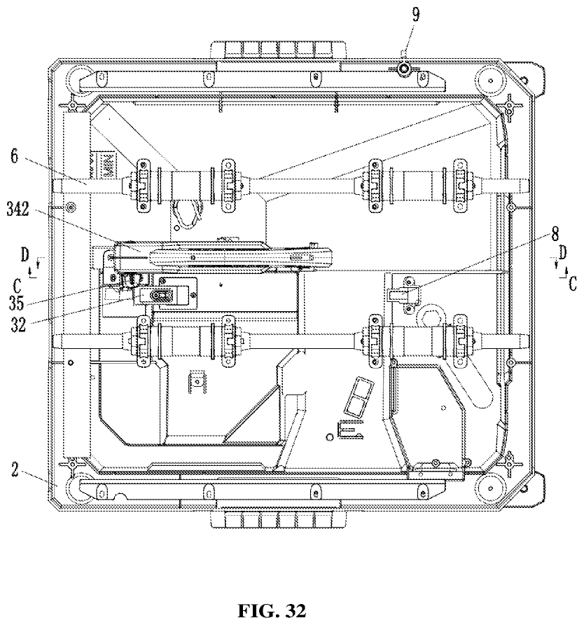

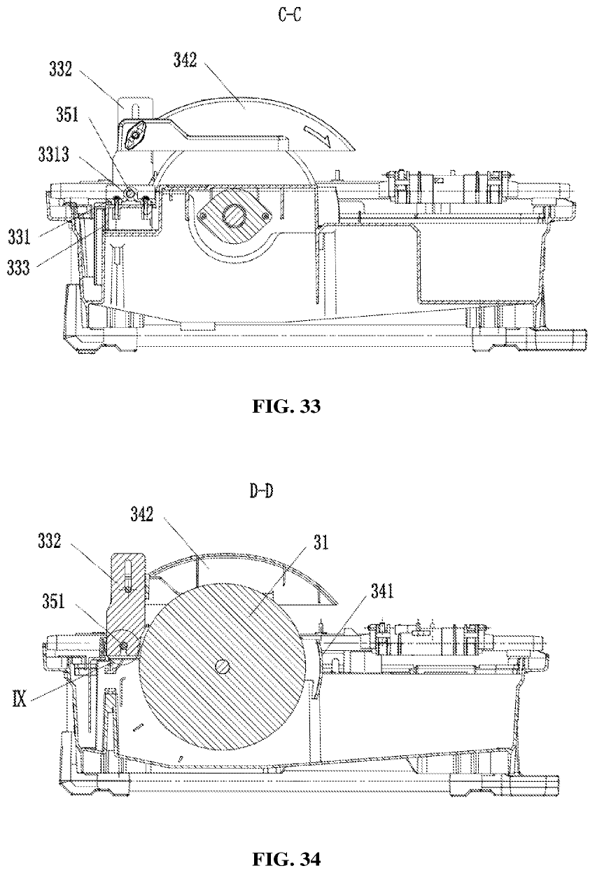

As shown in FIGS. 32 and 33, the protective system further includes an upper shield 342 covering the cutting member 31. Generally, the upper shield 342 is directly locked to the blade follower plate 332 by a locking button, a gap certainly exists between the upper shield 342 and the ceramic tile, and water mist is still splashed. In this example, a connector (not shown) is provided on the blade follower plate 332, and the upper shield 342 is connected to the blade follower plate 332 through the connector. The upper shield 342 can rotate slightly up and down about the connector, and the front end of the upper shield 342 presses a surface of the ceramic tile tightly under the gravity of the upper shield 342, thereby reducing the splashing of water mist. At least water mist at the front end is not splashed towards the user. A slight rotation enables the upper shield 342 not to interfere with the ceramic tile too much so that the ceramic tile can be passed smoothly. In another structure, a bolt in the locking button is replaced with a flat or square shaft so that a similar function can be implemented. The details are not repeated here. When the cutting member 31 is replaced by the user, the upper shield 342 and even more water blocking structures need to be removed. The upper shield 342 and the blade follower plate 332 are integrally detached and installed quickly so that user experience can be greatly improved.

As shown in FIG. 33, the blade follower plate 332 is provided with an elongated slot along a vertical direction, the upper shield 342 is provided with a connecting hole, and a fastener penetrates through the elongated slot and the connecting hole so that the upper shield 342 is connected to the blade follower plate 332. In an example, as shown in FIG. 34, the protective system includes a water baffle 341, where the water baffle 341 is disposed on a side of the cutting member 31 facing away from the blade follower assembly 33 to prevent a water flow from splashing from the underside of the platen 11 onto the user.

The protective system further includes a lower shield (not shown) covering the cutting member 31, where the lower shield is detachably connected to the blade follower assembly 33, and the lower shield is rotatable about a centerline parallel to the second direction so that when the cutting member 31 is replaced, the lower shield does not need to be detached, further simplifying operation steps of replacing the cutting member 31 and improving the user experience.

As shown in FIGS. 32 to 38, the blade follower assembly 33 includes the blade follower seat 331, the blade follower plate 332, and a locking assembly 35. In an example, the blade follower seat 331 is disposed on the box 2 and provided with a mounting hole. The blade follower plate 332 is disposed on the rear side of the cutting member 31 along the first direction 101 and detachably connected to the blade follower seat 331. The locking assembly 35 includes a locking shaft 351 disposed in the mounting hole. The locking assembly 35 has a locked state and an unlocked state with the blade follower plate 332. The locking assembly 35 in the locked state locks the blade follower seat 331 and the blade follower plate 332. When the locking assembly 35 is in the unlocked state, the blade follower seat 331 and the blade follower plate 332 can be separated from each other.

The upper shield 342 is connected to the blade follower plate 332. When the cutting member 31 is replaced, the locking assembly 35 is simply put in the unlocked state so that the blade follower plate 332 can be detached from the blade follower seat 331, so as to detach the upper shield 342. When the locking assembly 35 is put in the locked state, the blade follower plate 332 can be mounted to the blade follower seat 331. The locking assembly 35 is operated so that the blade follower plate 332 is detached from and mounted to the blade follower seat 331, which is convenient to operate. The locking shaft 351 is disposed in the mounting hole so that the locking shaft 351 can be connected to the blade follower seat 331, the locking assembly 35 is stably connected to the blade follower seat 331, and connection reliability between the blade follower plate 332 and the blade follower seat 331 can be improved. A fastener is replaced with the locking assembly 35 so that the following case is avoided: the fastener is loosened during long-term use or transportation, resulting in unstable connection between the blade follower plate 332 and the blade follower seat 331. The connection reliability is improved through the locking assembly 35.

In this example, as shown in FIGS. 32 to 38, the blade follower plate 332 is provided with a first connecting hole 3321 and a second connecting hole 3322 which communicate with each other. The locking shaft 351 can penetrate through the mounting hole and the first connecting hole 3321, and the locking shaft 351 has a first connecting portion 3511 and a second connecting portion 3512 in a circumferential direction. When the locking assembly 35 is in the locked state, the second connecting portion 3512 faces the second connecting hole 3322, and the locking shaft 351 is engaged in the first connecting hole 3321. When the locking assembly 35 is in the unlocked state, the first connecting portion 3511 faces the second connecting hole 3322, and the locking shaft 351 can be separated from the blade follower plate 332 through the second connecting hole 3322.

During operation, the locking shaft 351 is rotated so that the second connecting portion 3512 faces the second connecting hole 3322, the locking shaft 351 is engaged in the first connecting hole 3321, and the locking assembly 35 is in the locked state. The locking shaft 351 is rotated so that the first connecting portion 3511 faces the second connecting hole 3322, the locking shaft 351 is separated from the blade follower plate 332 through the second connecting hole 3322, and the locking assembly 35 is in the unlocked state. The shapes and sizes of the first connecting hole 3321 and the second connecting hole 3322 and the shapes and sizes of the first connecting portion 3511 and the second connecting portion 3512 are set so that the locking shaft 351 and the blade follower plate 332 can be locked or unlocked by simply rotating the locking shaft 351, which are simple and reliable in structure and convenient to use. Additionally, the locking shaft 351 is engaged in the first connecting hole 3321 so that the blade follower plate 332 is prevented from rotating in the circumferential direction of the locking shaft 351 and prevented from being loosened along the circumferential direction, thereby improving mounting accuracy.

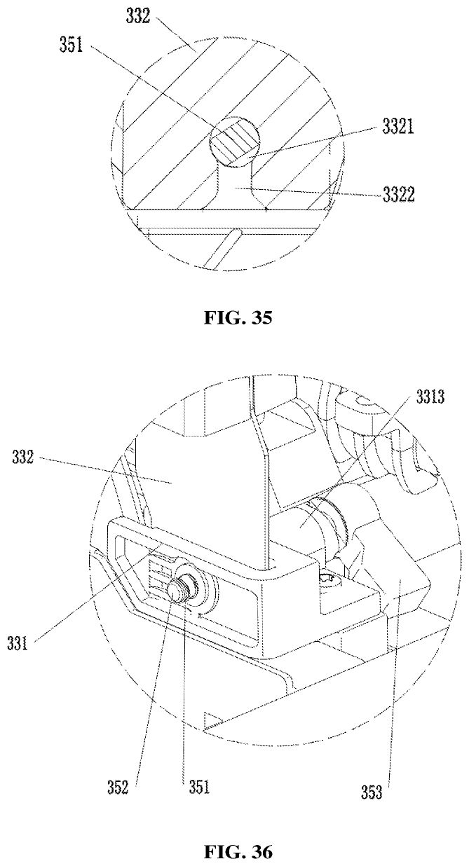

With continued reference to FIG. 35, the first connecting hole 3321 is a circular hole, a cross-section of the first connecting portion 3511 is arc-shaped, and the arc radius of the first connecting portion 3511 is the same as the radius of the first connecting hole 3321. A cross-section of the second connecting portion 3512 is flat, the second connecting hole 3322 is a flat hole, the width of the second connecting portion 3512 is not greater than the width of the second connecting hole 3322, and the diameter of the first connecting hole 3321 is greater than the width of the second connecting hole 3322. As shown in FIGS. 34 and 35, when the flat cross-section faces the flat hole, the arc-shaped cross-section is engaged in the circular hole so that the blade follower plate 332 and the locking shaft 351 are locked. When the arc-shaped cross-section faces the flat hole, the flat cross-section can enter the flat hole, and the width of the flat cross-section is not greater than the width of the flat hole so that the blade follower plate 332 can be separated from the locking shaft 351. The circular hole and the arc-shaped first connecting portion 3511 are disposed so that the locking shaft 351 is convenient to rotate in the circular hole. In this example, two opposite flat second connecting portions 3512 and two opposite arc-shaped first connecting portions 3511 are included, and the first connecting portion 3511 and the second connecting portion 3512 are alternately arranged.

In this example, as shown in FIGS. 35, 37, and 38, an opening is provided on a side of the second connecting hole 3322 facing away from the first connecting hole 3321, and the second connecting portion 3512 can enter and exit the second connecting hole 3322 through the opening so that the blade follower plate 332 can be separated from the blade follower plate seat 331 through the opening. In this example, the opening faces downwards, and the blade follower plate 332 can be pulled upward to facilitate detachment. In other examples, the opening may be disposed correspondingly according to structures such as the blade follower seat 331 and face in other directions as long as the operation is facilitated.

In other examples, when the second connecting hole 3322 has no opening, the locking shaft 351 may be extracted from the second connecting hole 3322.

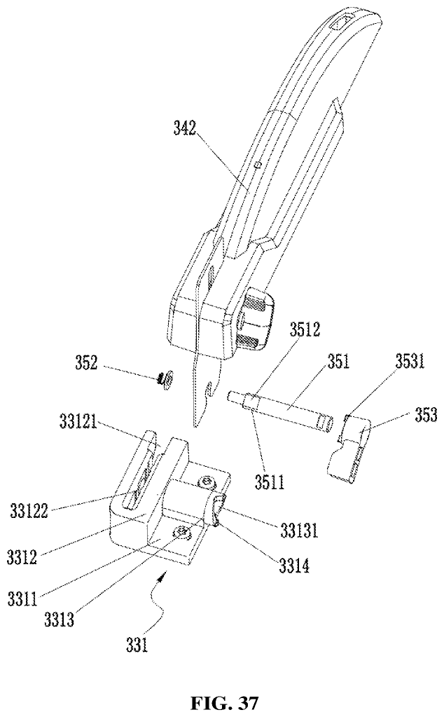

As shown in FIG. 37, the locking assembly 35 further includes a handle 353 connected to an end of the locking shaft 351, the handle 353 is provided with a first indicator protrusion 3531, and the blade follower seat 331 is provided with a second indicator protrusion 3314. When the locking assembly 35 is in the locked state, the first indicator protrusion 3531 and the second indicator protrusion 3314 are staggered, the first indicator protrusion 3531 can abut against the blade follower seat 331, and the second indicator protrusion 3314 abuts against the handle 353 so that the first indicator protrusion 3531 and the second indicator protrusion 3314 can perform not only axial limitation but also circumferential limitation, achieving safety protection. When the locking assembly 35 is in the unlocked state, the first indicator protrusion 3531 abuts against the second indicator protrusion 3314 to act as an indicator. Before the cutting device 10a performs cutting, it is necessary to confirm that the locking assembly 35 is in the locked state; otherwise, a danger occurs.

As shown in FIGS. 36 to 38, the blade follower seat 331 includes a blade follower seat body 3311 and a first mounting boss 3312 disposed on the blade follower seat body 3311, the first mounting boss 3312 is provided with a limiting slot 33121, and the blade follower plate 332 can be inserted into the limiting slot 33121. The first mounting boss 3312 is further provided with the mounting hole, and slot walls of the limiting slot 33121 can limit the blade follower plate 332, thereby improving the mounting accuracy of the blade follower plate 332. In this example, the limiting slot 33121 limits two sidewalls of the blade follower plate 332 in the second direction.

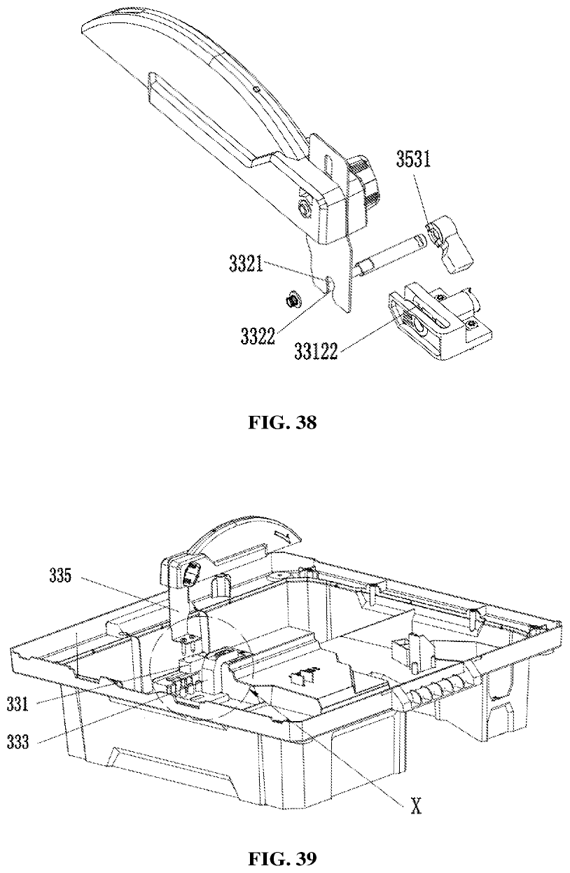

In this example, as shown in FIGS. 37 and 38, limiting protrusions 33122 are provided on the slot walls of the limiting slot 33121, and the limiting protrusions 33122 are in contact with side surfaces of the blade follower plate 332, thereby further improving the mounting accuracy of the blade follower plate 332 in the second direction.

Optionally, as shown in FIGS. 36 to 38, the locking assembly 35 further includes an elastic stop piece 352, the locking shaft 351 penetrates through the mounting hole, an end of the elastic stop piece 352 is fixed to a protruding end of the locking shaft 351, and the other end of the elastic stop piece 352 can elastically abut against the first mounting boss 3312, thereby axially limiting the locking shaft 351. An end of the locking shaft 351 is limited by the elastic stop piece 352 and the first mounting boss 3312, and the other end of the locking shaft 351 is axially limited by the first indicator protrusion 3531 and the second indicator protrusion 3314. In an example, the elastic stop piece 352 includes a stop piece and a spring connected to a side of the stop piece, the stop piece abuts against the first mounting boss 3312, both the stop piece and the spring are sleeved on the locking shaft 351, and an end of the spring may be fixed to the locking shaft 351 in manners such as welding and abutting.

The blade follower seat 331 includes the blade follower seat body 3311 and a second mounting boss 3313 disposed on the blade follower seat body 3311, the second mounting boss 3313 is provided with a limiting through hole 33131, the locking shaft 351 can penetrate through the limiting through hole 33131, the limiting through hole 33131 communicates with the mounting hole, and the limiting through hole 33131 is used for radially limiting the locking shaft 351, thereby improving mounting reliability. During installation, the locking shaft 351 is directly inserted into the limiting through hole 33131, thereby reducing alignment and facilitating operation.

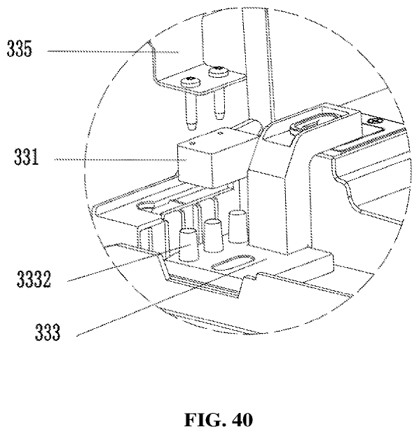

In another example shown in FIGS. 39 and 40, one of the adapter seat 333 and the blade follower seat 331 is provided with a boss 3332, and the other of the adapter seat 333 and the blade follower seat 331 is provided with an insertion hole into which the boss 3332 can be inserted. The boss 3332 and the insertion hole mate with each other so that a fit with no clearance can be achieved, thereby improving the mounting accuracy of the adapter seat 333 and the blade follower seat 331. When the blade follower plate 332 is detached, the blade follower plate 332 and the blade follower seat 331 can be simultaneously pulled out of and inserted again into the adapter seat 333 without a loss of the previous adjustment accuracy, facilitating detachment and installation. In this example, the adapter seat 333 is provided with the boss 3332, and the blade follower seat 331 is provided with the insertion hole. The adapter seat 333 may be provided with multiple bosses 3332, to implement position adjustment.

As shown in FIG. 40, the boss 3332 is a truncated cone. A mating surface between the truncated cone and the insertion hole has a small draft angle so that the truncated cone and the insertion hole are not easily disengaged from each other during use, and a tilt angle of the truncated cone has a guiding effect, thereby facilitating installation. In other examples, the boss 3332 may be a cylinder or half or a fraction of a cone, which is not limited.

As shown in FIGS. 39 and 40, the structure is different from the structure of the blade follower plate 332 shown in FIG. 38. In this example, the blade follower assembly 33 includes an L-shaped blade follower plate 335, the L-shaped blade follower plate 335 includes a horizontal plate and a vertical plate which are interconnected, the vertical plate is disposed on a side of the cutting member 31 along the first direction, the upper shield 342 is connected to the vertical plate, and the horizontal plate is connected to the blade follower seat through fasteners, facilitating detachment and installation.

What is claimed is:

1. A cutting device, comprising a box, a workbench disposed on the box, and a cutting assembly disposed on the box, wherein the workbench comprises a platen for supporting a workpiece, the platen is slidably connected to the box along a first direction, the cutting device further comprises a slide assembly for making the platen slide relative to the box, the slide assembly comprises a track and a sliding sleeve moving on the track, and the sliding sleeve is capable of partially sliding out of the track.

2. The cutting device of claim 1, wherein a slide stroke of the platen is greater than a length of the track.

3. The cutting device of claim 1, wherein the sliding sleeve has a motion slot through which the sliding sleeve is capable of sliding out of an end of the track.

4. The cutting device of claim 1, wherein the track is connected to the box, the sliding sleeve is connected to the workbench, and the sliding sleeve has a motion slot through which the sliding sleeve is capable of sliding out of an end of the track.

5. The cutting device of claim 4, wherein the track has a connecting portion through which the track is disposed on the box, the sliding sleeve is sleeved on the track and slidably connected to the track, and the motion slot is capable of passing the connecting portion.

6. The cutting device of claim 5, wherein the sliding sleeve comprises a bearing with a first slot forming part of a motion slot, and balls in contact with the track are provided in the first slot.

7. The cutting device of claim 6, wherein an inner wall of the bearing adapts to an appearance of the track and is provided with a plurality of mounting slots, and a plurality of lines of balls are provided, wherein one of the plurality of lines of balls is mounted in each of the plurality of mounting slots.

8. The cutting device of claim 7, wherein the sliding sleeve further comprises a housing with a second slot, the housing is sleeved on an outer circumference of the bearing, the second slot forms part of the motion slot, and the housing is connected to the workbench.

9. The cutting device of claim 1, wherein a guide rail assembly is provided between the workbench and the box, the guide rail assembly comprises a first guide rail disposed on the workbench and a second guide rail disposed on the box, and the first guide rail and the second guide rail mate with each other and move relatively.

10. A cutting device, comprising a box, a workbench disposed on the box, and a cutting assembly disposed on the box, wherein the workbench comprises a platen for carrying a workpiece, the platen is provided with a first cutting slot along a first direction, the platen is slidably connected to the box along the first direction, the cutting assembly penetrates through the first cutting slot so that the cutting assembly cuts the workpiece on the platen when the platen slides towards the cutting assembly, the cutting device further comprises a power supply assembly, a surface of the platen has a working plane, the platen has a first projection on the working plane, the power supply assembly has a second projection on the working plane, and the second projection is at least partially within the first projection.

11. A cutting device, comprising a box, a workbench disposed on the box, and a cutting assembly disposed on the box, wherein the workbench comprises a platen for supporting a workpiece, the platen is provided with a first cutting slot along a first direction, the platen is slidably connected to the box along the first direction, the cutting assembly penetrates through the first cutting slot so that the cutting assembly cuts the workpiece on the platen when the platen slides towards the cutting assembly, and a slide stroke of the platen is greater than a cutting stroke of the workpiece.

12. The cutting device of claim 11, further comprising a drive assembly and a power supply assembly which are disposed on the box, wherein the power supply assembly is used for supplying power to the drive assembly and disposed outside the box.

13. The cutting device of claim 12, wherein a surface of the platen has a working plane, the platen has a first projection on the working plane, the power supply assembly has a second projection on the working plane, and the second projection is within the first projection.

14. The cutting device of claim 12, further comprising the drive assembly and a switch which are disposed on the box, wherein the switch is used for controlling the drive assembly and disposed outside the box.

15. The cutting device of claim 11, further comprising a slide assembly comprising a track and a sliding sleeve moving on the track, wherein the track is connected to the box, and the sliding sleeve is connected to the platen.

16. The cutting device of claim 15, wherein the sliding sleeve has a motion slot, the sliding sleeve is capable of sliding out of an end of the track through the motion slot so that the slide stroke of the platen is greater than or equal to a length of the track.

17. The cutting device of claim 11, further comprising a main fence detachably connected to the platen, wherein the workpiece abuts against a first side of the main fence.

18. The cutting device of claim 17, wherein a plurality of mounting positions are provided on the platen, when the main fence is separately mounted at the plurality of mounting positions, the first side of the main fence and the first direction are at different angles, and the main fence is capable of being selectively mounted at one of the plurality of mounting positions.

19. The cutting device of claim 17, wherein the first side of the main fence is recessed towards a second side of the main fence to form a second cutting slot, and the second cutting slot communicates with the first cutting slot when the first side of the main fence is perpendicular to the first cutting slot.

20. The cutting device of claim 11, further comprising a slide assembly for connecting the platen to the box to make the platen slide relative to the box, wherein the slide assembly comprises a track and a sliding sleeve moving on the track, and the slide stroke of the platen is greater than or equal to a length of the track.
